(19) United States
(12) Patent Application Publication
(10) Pub. No.: US 2009/0309445 A1
(43) Pub. Date: Dec. 17, 2009

(54) Low Torque Rotary Electric Generator

(76) Inventor: Daniel L. Quale, Jefferson, WI (US)

Correspondence Address: DONALD J. ERSLER, S.C., 725 GARVENS AVENUE, BROOKFIELD, WI, 53005, US

(21) Appl. No.: 12/138,052

(22) Filed: Jun. 12, 2008

(51) Int. Cl. H02K 1/06

(52) U.S. Cl. 310/155

(57) ABSTRACT

A low torque rotary electric generator includes a rotor, a stator and a housing. The rotor includes a shaft, an inductor retainer, a first set of inductors and a second set of inductors. The first and second set of inductors are retained on each end of the inductor retainer. The shaft is retained in the inductor retainer. The stator preferably includes a first permanent ring magnet, a second permanent ring magnet and a plurality of generator coils. The permanent ring magnets and the plurality of generator coils are retained on an inside perimeter of the housing. The permanent ring magnets are retained adjacent each end of the rotor. Each permanent ring magnet may be replaced with a plurality of individual permanent magnets. Each generator coil is disposed between the first and second inductors. The housing preferably includes a tubular member, a first end cover and a second end cover.

### BACKGROUND OF THE INVENTION

1. Field of the Invention

The present invention relates generally to generators and more specifically to a low torque rotary electric generator, which is more efficient to operate than that of the prior art.

2. Discussion of the Prior Art

U.S. Pat. No. 3,879,622 to Ecklin discloses a permanent magnet motion conversion device. The Ecklin patent discloses a permanent magnet motor with a spring-biased reciprocating magnetizable member positioned between two permanent magnets.

Accordingly, there is a clearly felt need in the art for a low torque rotary electric generator, which is more efficient to operate than that of the prior art.

### SUMMARY OF THE INVENTION

The present invention provides a low torque rotary electric generator, which is more efficient to operate than that of the prior art. The low torque rotary electric generator includes a rotor, a stator and a housing. The rotor includes a shaft, an inductor retainer, a first set of inductors and a second set of inductors. The first set of inductors are retained on one end of the inductor retainer and the second set of inductors are retained on the other end. The shaft is inserted through a center of the inductor retainer. The stator preferably includes a first permanent ring magnet, a second permanent ring magnet and a plurality of generator coils. The permanent ring magnets and the plurality of generator coils are retained on an inside perimeter of the housing. The permanent ring magnets are retained adjacent each end of the rotor. An air gap is maintained between the permanent ring magnets and the inductors. Each permanent ring magnet may be replaced with a plurality of permanent magnets and a permanent ring magnet holder. Each generator coil is disposed between the first and second set of inductors. An air gap is maintained between each end of the generator coils and the first and second sets of inductors. The housing preferably includes a tubular member, a first end cover and a second end cover.

Accordingly, it is an object of the present invention to provide a low torque rotary electric generator, which is more efficient to operate than that of the prior art.

These and additional objects, advantages, features and benefits of the present invention will become apparent from the following specification.

### BRIEF DESCRIPTION OF THE DRAWINGS

FIG. 1 is a cross-sectional view of a low torque rotary electric generator cut along a length thereof in accordance with the present invention.

FIG. 2 is a cross-sectional view of a low torque rotary electric generator cut across a length thereof in accordance with the present invention.

FIG. 3 is a cross-sectional view of a second embodiment of a low torque rotary electric generator cut along a length thereof in accordance with the present invention.

FIG. 4 is a cross-sectional view of a second embodiment of a low torque rotary electric generator cut across a length thereof in accordance with the present invention.

FIG. 5 is an end view of a first end of a low torque rotary electric generator in accordance with the present invention.

FIG. 6 is a schematic illustrating how magnetic flux from a first permanent magnet is diverted by one of a first set of inductors, which allows a second permanent magnet to couple magnetic flux therefrom to a generator coil in accordance with the present invention.

FIG. 7 is a schematic illustrating how magnetic flux from a second permanent magnet is diverted by one of a second set of inductors, which allows a first permanent magnet to couple magnetic flux therefrom to a generator coil in accordance with the present invention.

### DETAILED DESCRIPTION OF THE PREFERRED EMBODIMENTS

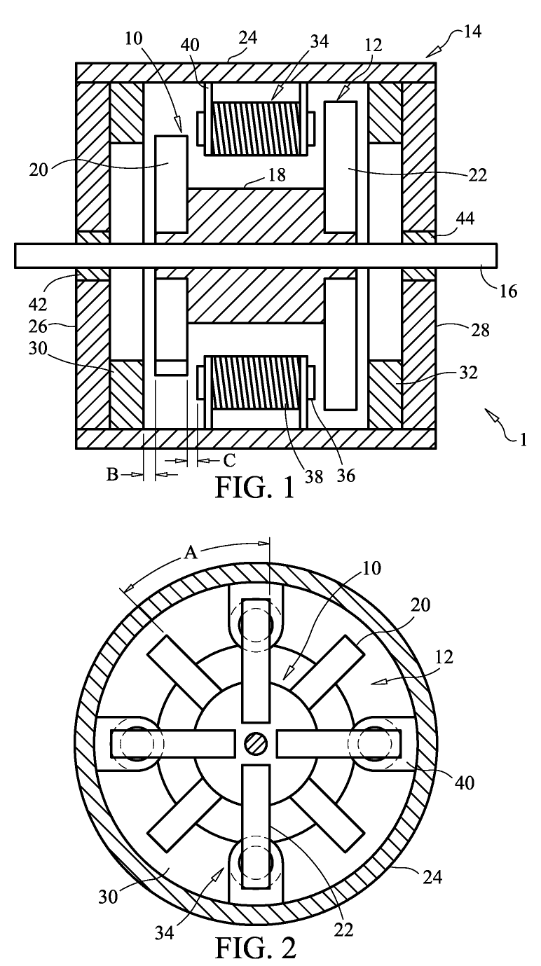

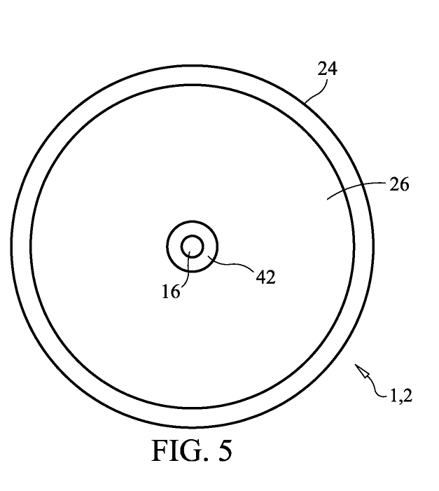

With reference now to the drawings, and particularly to FIG. 1, there is shown a cross-sectional view of a low torque rotary electric generator 1. With reference to FIGS. 1, 2 and 5. The low torque rotary electric generator 1 includes a rotor 10, a stator 12 and a housing 14. The rotor 10 includes a shaft 16, an inductor retainer 18, a first set of inductors 20 and a second set of inductors 22. The first set of inductors 20 are retained on one end of the inductor retainer 18 and the second set of inductors 22 are retained on the other end. The first set of inductors 20 are preferably staggered from the second set of inductors 22 by an angle “A.” Angle “A” preferably has a value of 45 degrees, but other values could also be used. The inductor retainer 18 is retained on the shaft 16. The inductor retainer 18 preferably has a substantially cylindrical shape. The first and second sets of inductors are fabricated from a magnetizable material.

The housing 14 preferably includes a tubular member 24, a first end cover 26 and a second end cover 28. The stator 12 preferably includes a first permanent ring magnet 30, a second permanent ring magnet 32 and a plurality of generator coils 34. The first and second permanent ring magnets are retained in an inner perimeter of the tubular member 24 in opposing ends thereof. Each generator coil 34 includes a magnetizable core 36 and a coil winding 38. The magnetizable core 36 is preferably fabricated from iron, but could be fabricated from any other magnetizable material. The plurality of coil windings 38 may be electrically connected together in parallel or series. Electricity is taken from each coil winding 38 at appropriately placed taps or ends of the coil winding 38 as is presently done in the prior art. Each generator coil 34 is retained relative to an inner perimeter of the tubular member 24 with a pair of retention tabs 40. Each retention tab 40 includes a hole for receiving the magnetizable core 36. The retention tabs 40 are preferably attached to the inner perimeter of the tubular member 24 with welding or any other suitable attachment method.

An air gap “B” is maintained between the first permanent ring magnet 30 and an outer surface of the plurality of first inductors 20, and the outer surface of the plurality of second inductors 22 and the second permanent ring magnet 32. The air gap “B” has a preferable dimension based on minimizing magnetic leakage between the inductors 20, 22 and the generator coils 34. An air gap “C” is maintained between an inner surface of the plurality of first inductors 20 and one end of the plurality of magnetizable cores 36, and an inner surface of the plurality of second inductors 22 and the other end of the plurality of magnetizable cores 36. The air gap “C” has a preferable dimension based on minimizing magnetic leakage between the inductors 20, 22 and the generator coils 34.

Minimizing magnetic leakage provides for a maximum differential of magnetic flux across the generator coils 34 created by the rotating inductors 20, 22. The dimensions of air gaps “B” and “C” will vary based on the size, strength and material composition of the permanent magnets 30, 32, the inductors 20, 22 and the generator coils 34. The purpose of the inductors 20, 22 is to absorb magnetic flux from an adjacent permanent magnet 30, 32, thus allowing the flux from the opposing permanent magnet 32, 30 to establish a field through the magnetizable cores 36. As the rotor 10 spins, alternating electrical fields are induced in the coil windings 38 from the magnetizable cores 36. Finally, both north or south poles of the permanent magnets 30, 32 must be oriented to face each other or face into the housing 14.

The first end cover 26 is preferably pressed into an inner perimeter of the tubular member 24 at one end thereof. The second end cover 28 is preferably pressed into an inner perimeter of the tubular member 24 at the other end thereof. However, other methods of securing first and second end covers may also be used. A first shaft bearing 42 is pressed into the first end cover 26 to rotatably receive one end of the shaft 16 and a second shaft bearing 44 is pressed into the second end cover 26 to rotatably receive the other end of the shaft 16. Rotation of the shaft 16 generates electrical current flow in the plurality of coil windings 38.

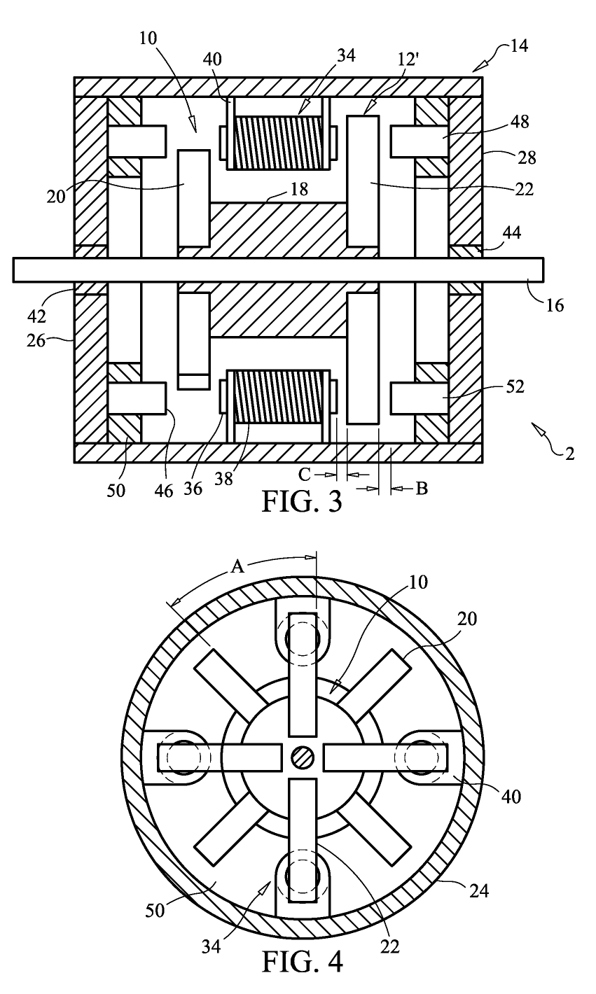

With reference to FIGS. 3-4, a second embodiment of a low torque rotary electric generator 2 includes the rotor 10, a stator 12′ and the housing 14. The rotor 10 includes the shaft 16, the inductor retainer 18, the first set of inductors 20 and the second set of inductors 22. The housing 14 preferably includes the tubular member 24, the first end cover 26 and the second end cover 28. The stator 12′ preferably includes a plurality of first permanent magnets 46, a second plurality of second permanent magnets 48, a first permanent magnet holder 50, a second permanent magnet holder 52 and the plurality of generator coils 34.

The plurality of first permanent magnets 46 are preferably pressed into the first permanent magnet holder 50 and the second plurality of second permanent magnets 48 are preferably pressed into the second permanent magnet holder 52. The first and second permanent magnet holders are retained in an inner perimeter of the tubular member 24 in opposing ends thereof. The first and second permanent magnet holders are preferably fabricated of a nonmagnetic material. Each generator coil 34 includes the magnetizable core 36 and the coil winding 38. Each generator coil 34 is retained relative to an inner perimeter of the tubular member 24 with a pair of retention tabs 40. The permanent magnets 46, 48 are substantially concentric with the magnetizable cores 36.

The first shaft bearing 42 is retained in the first end cover 26 and the second shaft bearing 44 is retained in the second end cover 28. Rotation of the shaft 16 generates electrical current flow in the plurality of coil windings 38. The low torque rotary electric generator 2 is identical to the low torque rotary electric generator 1 with the exception of the first and second plurality of permanent ring magnets.

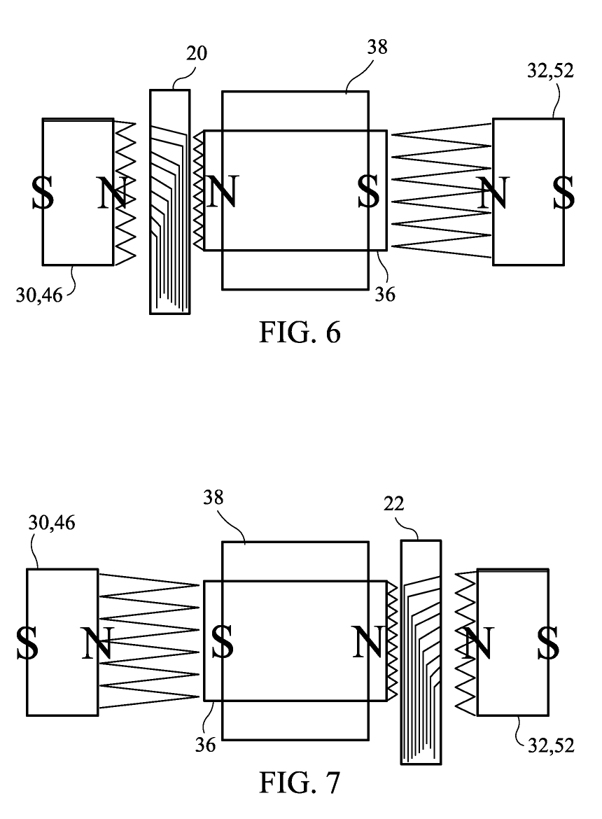

FIG. 6 illustrates how magnetic flux from the first permanent magnet 30, 46 is diverted by one of the first set of inductors 20, which allows the second permanent magnet 32, 52 to couple magnetic flux therefrom to one of the generator coils 34. The diversion of the magnetic flux results in an induced electrical potential in the coil winding 38, due to the flux from the second permanent magnet 32, 52, which magnetizes the generator core 36 causing a magnetic field therein to align with the magnetic field from the second permanent magnet 32, 52.

FIG. 7 illustrates how magnetic flux from the second permanent magnet 32, 52 is diverted by one of the second set of inductors 20, which allows the first permanent magnet 30, 46 to couple magnetic flux therefrom to one of the generator coils 34. The diversion of the magnetic flux results in an induced electrical potential in the coil winding 38, due to the flux from the first permanent magnet 30, 46, which magnetizes the generator core 36 causing a magnetic field therein to align with the magnetic field from the first permanent magnet 30, 46. Combined together, FIGS. 6 and 7 depict how rotation of the rotor 10 creates an alternating electrical current output in the generator coils 34.

Four generator coils 34, four first inductors 20 and four second inductors 22 are shown in FIGS. 1-4. However, the low torque rotary electric generator 1, 2 should not be limited to only four generator coils 34, four first inductors 20 and four second inductors 22, but may include any suitable number.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A low torque rotary electric generator comprising:
a housing including a tubular member;
a rotor including a first set of inductors disposed on one end and a second set of inductors disposed on the other end, said rotor being rotatably supported on each end of said housing; and
a stator including a first permanent ring magnet, a second permanent ring magnet and a plurality of generator coils, said plurality of generator coils being disposed on an inside perimeter of said tubular member, said first permanent ring magnet being disposed on one end of said housing, said second permanent ring magnet being disposed on the other end of said housing.

2. The low torque rotary electric generator of claim 1, further comprising:
each one of said plurality of generator coils including a magnetizable core and a coil winding.

3. The low torque rotary electric generator of claim 1, further comprising:
a first end cover being secured to one end of said tubular member, a second end cover being secured to the other end of said tubular member.

4. The low torque rotary electric generator of claim 2, further comprising:
a first shaft bearing being retained in said first end cover, a second shaft bearing being retained in said second end cover.

5. The low torque rotary electric generator of claim 1, further comprising:
said first set of inductors being retained on one end of an inductor holder, said second set of inductors being retained on the other end of said inductor holder.

6. The low torque rotary electric generator of claim 1, wherein:
staggering said first set of inductors relative to said second set of inductors.

7. The low torque rotary electric generator of claim 1, wherein:
said first permanent ring magnet including a plurality of individual first permanent magnets retained in a first permanent ring magnet holder, said second permanent ring magnet including a plurality of individual second permanent magnets retained in a second permanent ring magnet holder.

8. A low torque rotary electric generator comprising:
a housing including a tubular member;
a rotor including a first set of inductors disposed on one end and a second set of inductors disposed on the other end, said rotor being rotatably supported on each end of said housing; and
a stator including a first permanent ring magnet, a second permanent ring magnet and a plurality of generator coils, said plurality of generator coils being disposed on an inside perimeter of said tubular member, said first permanent ring magnet being disposed on one end of said housing, said second permanent ring magnet being disposed on the other end of said housing, wherein said first set of inductors being disposed between said first permanent ring magnet and one end of said plurality of generator coils, said second set of inductors being disposed between said second permanent ring magnet and the other end of said plurality of generator coils.

9. The low torque rotary electric generator of claim 8, further comprising:
each one of said plurality of generator coils including a magnetizable core and a coil winding.

10. The low torque rotary electric generator of claim 8, further comprising:
a first end cover being secured to one end of said tubular member, a second end cover being secured to the other end of said tubular member.

11. The low torque rotary electric generator of claim 10, further comprising:
a first shaft bearing being retained in said first end cover, a second shaft bearing being retained in said second end cover.

12. The low torque rotary electric generator of claim 8, further comprising:
said first set of inductors being retained on one end of an inductor holder, said second set of inductors being retained on the other end of said inductor holder.

13. The low torque rotary electric generator of claim 8, wherein:
staggering said first set of inductors relative to said second set of inductors.

14. The low torque rotary electric generator of claim 8, wherein:
said first permanent ring magnet including a plurality of individual first permanent magnets retained in a first permanent ring magnet holder, said second permanent ring magnet including a plurality of individual second permanent magnets retained in a second permanent ring magnet holder.

15. A low torque rotary electric generator comprising:
a housing including a tubular member;
a rotor including a first set of inductors disposed on one end and a second set of inductors disposed on the other end, said rotor being rotatably supported on each end of said housing; and
a stator including a first permanent ring magnet, a second permanent ring magnet and a plurality of generator coils, each one of said plurality of generator coils including a magnetizable core and a coil winding, said plurality of generator coils being disposed on an inside perimeter of said tubular member, said first permanent ring magnet being disposed on one end of said housing, said second permanent ring magnet being disposed on the other end of said housing.

16. The low torque rotary electric generator of claim 15, further comprising:
a first end cover being secured to one end of said tubular member, a second end cover being secured to the other end of said tubular member.

17. The low torque rotary electric generator of claim 16, further comprising:
a first shaft bearing being retained in said first end cover, a second shaft bearing being retained in said second end cover.

18. The low torque rotary electric generator of claim 15, further comprising:
said first set of inductors being retained on one end of an inductor holder, said second set of inductors being retained on the other end of said inductor holder.

19. The low torque rotary electric generator of claim 15, wherein:
staggering said first set of inductors relative to said second set of inductors.

20. The low torque rotary electric generator of claim 15, wherein:
said first permanent ring magnet including a plurality of individual first permanent magnets retained in a first permanent ring magnet holder, said second permanent ring magnet including a plurality of individual second permanent magnets retained in a second permanent ring magnet holder.
